(19) United States
(12) Patent Application Publication
(10) Pub. No.: US 2014/0368427 A1
(43) Pub. Date: Dec. 18, 2014

(54) Controlling Apparatus For Physical Effects In Cyberspace And Method Thereof

(71) Applicant: Woo Suck KYE, Seoul (KR)

(72) Inventor: Woo Suck KYE, Seoul (KR)

(21) Appl. No.: 14/288,218

(22) Filed: May 27, 2014

(30) Foreign Application Priority Data
Jun. 18, 2013 (KR) 10-2013-0069970

(51) Int. Cl. G06F 3/01

(52) U.S. Cl. CPC G06F 3/016
USPC 345/156

(57) ABSTRACT

Provided are a controlling apparatus for physical effects and a method thereof. After setting up a mapping relationship between at least one marker attached to a human body and an at least one effect output unit, a three-dimensional coordinate of the marker is recognized to be mapped onto cyberspace, and upon entry of the marker into a pre-set area within cyberspace, a physical effect output command is transmitted to the at least one effect output unit.

### RELATED APPLICATION

This application claims the benefit of Korean Patent Application No. 10-2013-0069970, filed on Jun. 18, 2013, in the Korean Intellectual Property Office, the disclosure of which is incorporated herein in its entirety by reference.

### BACKGROUND

1. Field

One or more embodiments of the present invention relate to a controlling apparatus for physical effects, such as vibration, heat, sound, or pressure, to allow a cybernaut to actually feel the physical effects, and a method thereof.

2. Description of the Related Art

In order to display a motion of a user in real space onto cyberspace, a three-dimensional coordinate of the user needs to be identified. In the related art, there is a method of identifying a three-dimensional coordinate by using a marker. That is, two-dimensional X-Y coordinates are found by using a projector and a depth sensing camera, in which the projector projects signals onto a marker and the depth sensing camera senses the signals reflected from a plurality of markers that reflect the signals sent from the projector; and three-dimensional locations are recognized by identifying a depth direction (i.e., a Z coordinate) by using marker size and signal intensity according to the distance between the depth sensing camera and each of the plurality of markers.

Besides the method above, a variety of techniques of reflecting a user's motion in real space into real-time three-dimensional cyberspace exist. However, there is a limit to implement virtual collision of cyberspace to allow a user to feel like real collision.

One of the related art patent documents is disclosed in Korean Patent Laid-open Publication No. KR 2013-0051134.

### SUMMARY

One or more embodiments of the present invention include a controlling apparatus for physical effects, such as virtual collision, in cyberspace to allow a user to actually feel the physical effects, and a method thereof.

Additional aspects will be set forth in part in the description which follows and, in part, will be apparent from the description, or may be learned by practice of the presented embodiments.

According to one or more embodiments of the present invention, a controlling apparatus for physical effects in cyberspace includes a marker recognition unit that recognizes a three-dimensional coordinate of at least one marker attached on a human body; a cyberspace mapping unit that maps the three-dimensional coordinate recognized by the marker recognition unit onto cyberspace; a storage unit that stores a mapping relationship between first and second inherent information, wherein the first inherent information is given to the at least one marker and the second inherent information is given to at least one effect output unit that outputs the physical effects; and a control unit that commands the at least one effect output unit to output physical effects that are pre-set with respect to a pre-determined area upon entry of the at least one marker into the pre-determined area within the cyberspace, wherein the effect output unit corresponds the second inherent information having the mapping relationship with the first inherent information of the entry marker.

According to one or more embodiments of the present invention, a method of controlling physical effects in cyberspace including setting up a mapping relationship between at least one marker attached to a human body and an at least one effect output unit; recognizing a three-dimensional coordinate of the at least one marker; mapping the three-dimensional coordinate of the at least one marker onto cyberspace; recognizing whether the at least one marker enters a pre-determined area within the cyberspace; and transmitting a physical effect output command to the at least one effect output unit in the mapping relationship with the at least one marker upon the entry of the at least one marker into the pre-determined area, wherein the physical effect output command is pre-set with respect to the pre-determined area.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram schematically illustrating a controlling system for physical effects in cyberspace according to an embodiment of the present invention;

FIG. 2 is a diagram illustrating a mapping relationship between a marker and an effect output unit according to another embodiment of the present invention;

FIG. 3 is a diagram illustrating configuration of a controlling apparatus for physical effects according to another embodiment of the present invention;

FIG. 4 is a diagram illustrating configuration of an effect output unit according to another embodiment of the present invention; and

FIG. 5 is a flowchart describing a method of controlling physical effects in cyberspace.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, a controlling apparatus for physical effects in cyberspace and a method thereof will be described in detail with reference to the accompanying drawings according to the present invention.

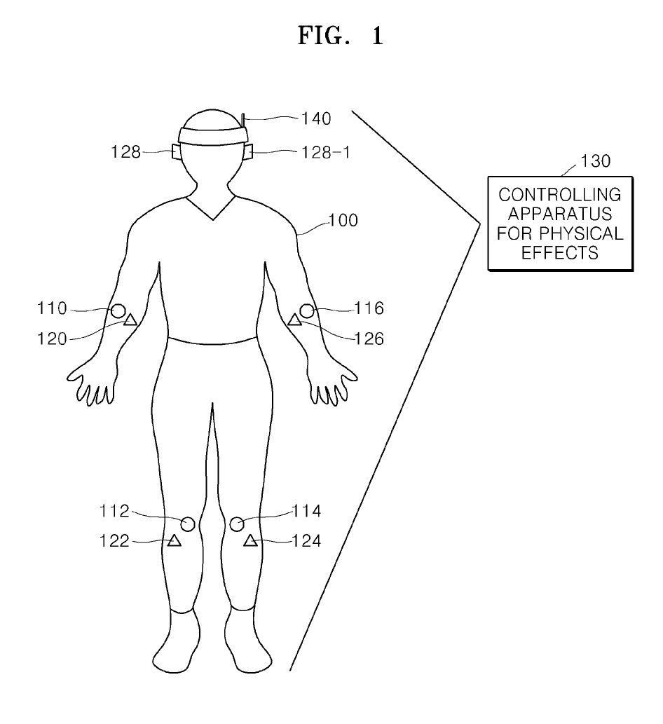

FIG. 1 is a diagram schematically illustrating a controlling system for physical effects in cyberspace according to an embodiment of the present invention.

Referring to FIG. 1, the illustrated embodiment is a case that a user 100 wears three-dimensional glasses 140 to experience cyberspace, but the case is not limited thereto. A variety of methods may be applied to allow the user 100 to experience cyberspace.

The user 100 has a plurality of markers 110, 112, 114, and 116 and a plurality of effect output units 120, 122, 124, 126, 128, and 128-1, in which the markers and the effect output units are attached on the user's body. The markers 110, 112, 114, and 116 are units of recognizing three-dimensional (3D) coordinates of the user 100, and the effect output units 120, 122, 124, 126, 128, and 128-1 are units of outputting physical effects, such as vibration, heat, or sound, that a person may feel.

The markers 110, 112, 114, and 116 may be passive markers that reflect signals (e.g., electrical signals) output from a controlling apparatus for physical effects 130, or may be active markers that emit signals by themselves. In the case of passive markers, the controlling apparatus for physical effects 130 allocates identification information to each of the markers 110, 112, 114, and 116 attached on the user's body. Then, the controlling apparatus for physical effects 130 recognizes 3D coordinates of the markers 110, 112, 114, and 116, and tracks movements that correspond to the 3D coordinates of the markers 110, 112, 114, and 116. Regarding passive markers, when each of the markers is overlapped according to a motion of the user 100 (for example, markers attached to both hands of the user are overlapped when a user overlaps both hands), there may be a difficulty in identifying each of the markers. However, regarding active markers, each of the markers transmits an identification signal so that the controlling apparatus for physical effects 130 may easily identify a location of each of the markers, regardless of the overlapping markers.

The controlling apparatus for physical effects 130 recognizes 3D coordinates of each of the markers using passive or active markers. In the related art, there are a variety of methods of identifying 3D coordinates by using the markers 110, 112, 114, and 116. However, a 3D coordinate identification method itself is out of the scope of the present invention, and thus, a detailed description thereof will be omitted herein.

The controlling apparatus for physical effects 130 maps 3D coordinates that are recognized by the markers 110, 112, 114, and 116 to be displayed onto cyberspace. The controlling apparatus for physical effects 130 displays a cybernaut (e.g., an avatar) representing the user 100 onto cyberspace or reflects a real image of the user 100 that is filmed by a real-time camera to be displayed onto cyberspace.

The controlling apparatus for physical effects 130 outputs various physical effects occurring according to the movements in cyberspace to allow the user 100 actually feel the physical effects through at least one of the effect output units 120, 122, 124, 126, 128, and 128-1 attached to the user 100. For example, the controlling apparatus for physical effects 130 recognizes a motion of the markers 112 and 114 each of which is attached on a knee of the user 100. In this regard, when the controlling apparatus for physical effects 130 recognizes collision of the user's knees to a desk that is present in cyberspace, the controlling apparatus for physical effects 130 commands the effect output units 122 and 124 to output vibration to allow the user 100 to feel the virtual collision like real collision in real space, wherein the effect output units 122 and 124 are in the mapping relationship with the markers 112 and 114 that are attached to the user's knees.

The effect output units 120, 122, 124, 126, 128, and 128-1 are devices for outputting physical effects, such as vibration, heat, sound, or pressure, through a vibrator, a heating unit, a speaker, or a pressure output unit, respectively, upon a command received from the controlling apparatus for physical effects 130. At least one of the effect output units 120, 122, 124, 126, 128, and 128-1 may output two or more physical effects, e.g., vibration and heat, together. For example, the effect output units 120, 122, 124, 126, 128, and 128-1 may be applied in the form of gloves that the user 100 wears so that the user 100 may feel pressure by controlling the degree of swelling of airbags equipped in the gloves. In addition, the effect output units 120, 122, 124, 126, 128, and 128-1 may be implemented in various items, such as clothes or hats, such that the user 100 may wear the items.

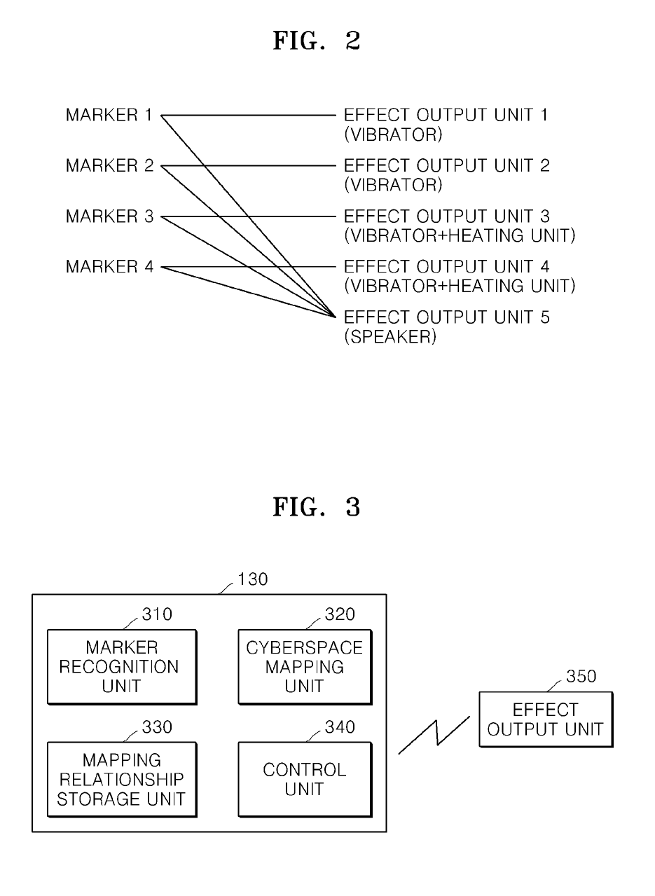

FIG. 2 is a diagram illustrating a mapping relationship between the marker and the effect output unit according to another embodiment of the present invention.

Referring to FIG. 2, the illustrated embodiment is a mapping relationship between four markers 110, 112, 114, and 116 and five effect output units 120, 122, 124, 126, 128, and 128-1, in which each of the four markers 110, 112, 114, and 116 is attached to arms and legs of the user 100 and each of the five effect output units 120, 122, 124, 126, 128, and 128-1 is attached to arms, legs, and ears of the user 100.

The markers 1 to 4 (i.e., 110, 112, 114, and 116) are in a mapping relationship with the effect output units 1 to 4 (i.e., 120, 122, 124, and 126), in which each of the markers 1 to 4 is present on the same location as that of each of the effect output units 1 to 4. In addition, the markers 1 to 4 (i.e., 110, 112, 114, and 116) are in a mapping relationship with an effect output units 5 (i.e., 128 and 128-1), in which the effect output unit 5 (i.e., 128 and 128-1) is present on ears of the user 100. Thus, the user 100 may feel vibration with sound or the like, by which the controlling apparatus for physical effects 130 commands the marker 1 (i.e., 110) and the effect output units 1 (i.e., 120) and 5 (128 and 128-1) mapped with the marker 1 to output physical effects corresponding to the marker 1 (i.e., 110).

The markers 110, 112, 114, and 116 and the effect output units 120, 122, 124, and 126 do not have to be present in the same position, and as shown in FIG. 2, each of the markers 110, 112, 114, and 116 may have a mapping relationship with many effect output units at a ratio of 1:N, or alternatively, many markers may have a mapping relationship with the same effect output unit at a ratio of N:1.

FIG. 3 is a diagram illustrating configuration of the controlling apparatus for physical effects 130 according to another embodiment of the present invention.

Referring to FIG. 3, the controlling apparatus for physical effects 130 includes a marker recognition unit 310, a cyberspace mapping unit 320, a mapping relationship storage unit 330, and a control unit 340.

The marker recognition unit 310 recognizes 3D coordinates of at least one of the markers attached on the human body. Here, the markers may be passive or active markers.

The cyberspace mapping unit 320 maps 3D coordinates of the marker onto cyberspace. The marker recognition unit 310 continuously recognizes 3D coordinates of the marker and recognizes real-time displacement of the marker, and accordingly, reflects the real-time displace of the marker to the cyberspace. That is, a motion of the user 100 in real space may be displayed as a motion in cyberspace.

The mapping relationship storage unit 330 stores a mapping relationship between the markers and the effect output units as shown in FIG. 2. For example, the mapping relationship storage unit 330 maps identification information of the marker and the effect output unit for the purpose of management.

If the marker or the effect output unit does not store identification information thereof, the mapping relationship storage unit 330 manages a mapping relationship therebetween by allocating identification information to the marker and the effect output unit that are attached on the human body for the purpose of management. Here, the same identification information may be given to the marker and the effect output unit in the mapping relationship.

In some embodiments, if the marker is an active marker that transmits identification information thereof, the mapping relationship storage unit 330 stores and manages identification information received from each of the markers attached on the human body and identification information given to the effect output unit.

In some other embodiments, if the effect output unit contains its identification information therein, the mapping relationship storage unit 330 maps and manages identification information received from the effect output unit attached on the human body and identification information of the marker.

The control unit 340 commands the effect output unit that is in the mapping relationship with the marker to output applicable physical effects upon entry of the marker by recognizing whether the marker enters a pre-determined area in cyberspace according to a motion of the user 100. The cyberspace used herein is literally an imaginary space, and thus, when the user 100 collides an obstacle that is present in the cyberspace, the user 100 may not actually feel or hear the collision.

Therefore, the control unit 340 sets in advance an area where an obstacle within cyberspace is located. The control unit 340 also sets in advance size or type of physical effects to be output in the applicable area. For example, the control unit 340 pre-sets a space for a glass bottle based on coordinates of the glass bottle present in cyberspace. Then, when the marker attached to the user's body enters the space where the glass bottle is located, the control unit 340 commands the effect output unit in the mapping relationship with the marker to output vibration or sound that is set in advance.

In some other embodiments, when the user 100 enters a virtual club implemented in cyberspace, the control unit 340 commands an effect output unit that is applicable to vibration to output the vibration from a speaker so that the user 100 may actually feel sound with vibration.

The control unit 340 may transmit information about physical effect size when the control unit 340 generates and transmits a command to output physical effects. Here, the physical effect size may be set in advance as a fixed value with respect to an area in cyberspace, or may be set as a dynamic value based on a speed at which the marker enters the area or a relative position of the marker within the area. Accordingly, the physical effect size may be transmitted to the effect output unit.

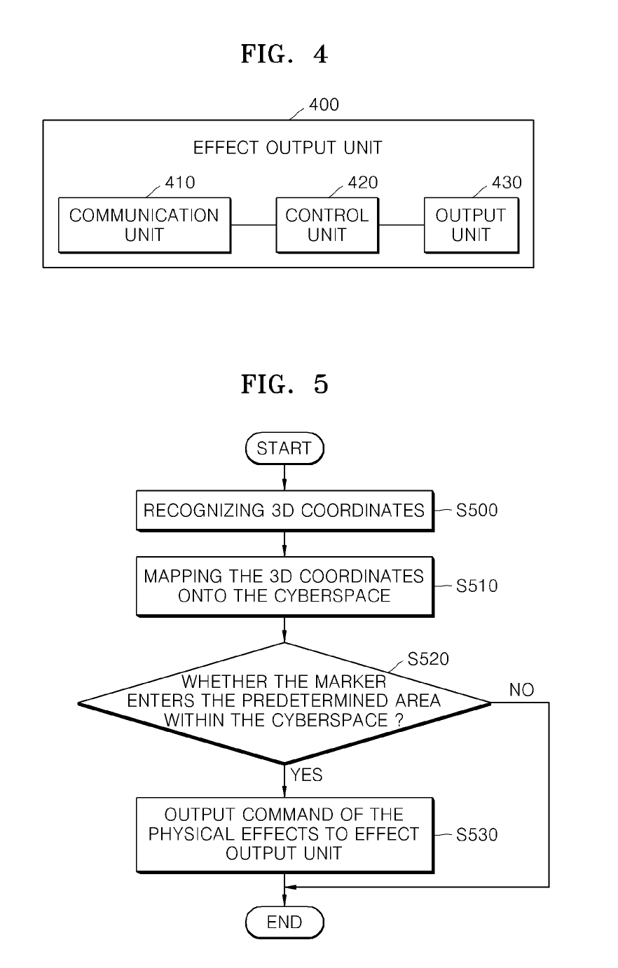

FIG. 4 is a diagram illustrating configuration of the effect output unit according to another embodiment of the present invention.

Referring to FIG. 4, the effect output unit 400 includes a communication unit 410, a control unit 420, and an output unit 430.

The communication unit 410 transmits or receives data such as a control command to or from the controlling apparatus for physical effects 130 via a variety of communication methods such as wired or wirelessly communication. The control unit 420 interprets the output command of physical effects received from the controlling apparatus for physical effects 130 so as to output applicable physical effects thereof.

When multiple effect output units are attached on the human body, each of the multiple effect output units needs to distinguish whether a command received from the controlling apparatus for physical effects 130 is relevant or not. In this regard, each of the multiple effect output units contains identification information in advance to be differentiated from other devices, or is assigned with identification information by the apparatus 130 for controlling physical effects.

The output unit 430 outputs physical effects, such as vibration, heat, sound, or pressure, through a vibrator, a heating unit, a speaker, or a pressure output unit, respectively, according to controls of the control unit 420. In the output unit 430, the output size of the physical effects (i.e., loudness, vibration amplitude, etc) are not always constant, and rather may be controlled by commands of the apparatus 130 for controlling physical effects.

FIG. 5 is a flowchart describing a method of controlling physical effects in cyberspace.

Referring to FIG. 5, the controlling apparatus for physical effects 130 recognizes 3D coordinates of at least one of the markers attached on the human body (step S500), and then, maps the 3D coordinates onto the cyberspace (step S510). The controlling apparatus for physical effects 130 recognizes whether the marker enters the pre-determined area within the cyberspace (step S520), and upon entry of the markers, the controlling apparatus for physical effects 130 transmits an output command of the physical effects that are set in advance in the corresponding area to at least one effect output unit that has a mapping relationship with the marker (step S530).

As described above, according to the one or more of the above embodiments of the present invention, a user may directly feel physical effects in cyberspace, such as vibration caused by virtual collision or the like, and thus may be more satisfied with a sense of reality in the cyberspace. For example, in the case of implementing a concert hall in cyberspace, low-pitched vibration felt over a large speaker may be output by an effect output unit attached on the user's body to allow the user to feel atmosphere of the real concert hall.

In addition, other embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A controlling apparatus for physical effects in cyberspace comprising:
a marker recognition unit that recognizes a three-dimensional coordinate of at least one marker attached on a human body;
a cyberspace mapping unit that maps the three-dimensional coordinate recognized by the marker recognition unit onto cyberspace;
a storage unit that stores a mapping relationship between first and second identification information, wherein the first identification information is allocated to the at least one marker and the second identification information is allocated to at least one effect output unit that outputs the physical effects; and
a control unit that commands the at least one effect output unit to output physical effects that are pre-set with respect to a pre-determined area upon entry of the at least one marker into the pre-determined area within the cyberspace, wherein the effect output unit corresponds the second identification information having the mapping relationship with the first identification information of the entry marker.

2. The controlling apparatus for physical effects of claim 1, wherein the physical effects comprise vibration, sound, or heat, and the effect output unit is attached to the human body to output the physical effects of vibration, sound, or heat through a vibrator, a speaker, or a heating unit.

3. The controlling apparatus for physical effects of claim 1, wherein the control unit recognizes a speed at which the marker enters the pre-determined area, and outputs a command including an output size of the physical effects according to the speed to a first effect output unit and a second effect output unit that are mapped with the entry marker, wherein the first effect output unit is present in the same position as that of the marker attached to the human body that enters the pre-determined area and outputs vibration according to the output size contained in the command, and wherein the second effect output unit is attached to ears of the human body and outputs sound according to the output size contained in the command.

4. The controlling apparatus for physical effects of claim 1, wherein the mapping relationship between the marker and the effect output unit is achieved at a ratio of 1:N (wherein N is a natural number of 2 or greater) or at a ratio of N:1.

5. The controlling apparatus for physical effects of claim 1, wherein the control unit outputs a command to the effect output unit via local area network.

6. A method of controlling physical effects in cyberspace, the method comprising:
setting up a mapping relationship between at least one marker attached to a human body and an at least one effect output unit;
recognizing a three-dimensional coordinate of the at least one marker;
mapping the three-dimensional coordinate of the at least one marker onto cyberspace;
recognizing whether the at least one marker enters a pre-determined area within the cyberspace; and
transmitting a physical effect output command to the at least one effect output unit in the mapping relationship with the at least one marker upon the entry of the at least one marker into the pre-determined area, wherein the physical effect output command is pre-set with respect to the pre-determined area.
